(19) United States
(12) Patent Application Publication
(10) Pub. No.: US 2012/0153550 A1
(43) Pub. Date: Jun. 21, 2012

(54) BUMPER FOR AIR SPRING

(76) Inventors: Tayfun Sigirtmaç, Bursa (TR); Mesut Sert, Bursa (TR)

(21) Appl. No.: 13/391,332

(22) PCT Filed: Aug. 19, 2010
(86) PCT No.: PCT/TR2010/000171

§ 371 Date: Feb. 20, 2012

(30) Foreign Application Priority Data
Aug. 19, 2009 (TR) 2009/06363

(51) Int. Cl. B60G 11/27; B29C 45/14; F16F 9/05

(52) U.S. Cl. 267/64.27; 264/279

(57) ABSTRACT

An air suspension system includes a plastic or metal piston fixed to the vehicle axle and an elastomeric bellows which is air tightly vulcanized from its lower open end to the upper part of the piston and from its upper open end to the metal plate fixed to the vehicle chassis to form a pressured air chamber and a single-piece bottom plate with bumper, which is completely made of reinforced plastic material. The air suspension system includes a compression part vulcanized to the elastomeric bellows and a bumper part absorbing the loads and which is mounted to the upper side of the piston after that it is vulcanized to the lower open end of the elastomeric bellows.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to air suspension systems which are used in transport vehicles such as articulated lorry, autobus, tractor, semi-trailer to provide constant vehicle height under all loading conditions, higher spring capability, ride comfort and vehicle level parallel to the road even with unbalanced loadings.

The present invention especially relates to the production of the bottom plate and bumper used in air suspension systems as a single-piece.

2. Description of Related Art

Including Information Disclosed Under 37 CFR 1.97 and 37 CFR 1.98.

Air suspension systems which are mounted between the chassis and the axle of the vehicles such as articulated lorry, autobus, tractor, semi-trailer by means of the connection parts, are used to absorb the vibrations caused by the way conditions, over load etc. during the riding. Air suspension systems generally comprise a plastic or metal piston fixed to the vehicle axle by means of a connection flange, an elastomeric air spring part vulcanized air tight manner from its lower open end to the upper part of the piston and from its upper open end to the metal plate which is fixed to the vehicle chassis. The inner volume of the elastomeric air spring part which is vulcanized air tightly to the piston and the plate, is filled with air provided by a compressor and passing through a hole on the plate and in conclusion the suspension system can absorb the vibrations.

At some types of the air springs, bottom plates, which are mounted on the upper side of the piston after that the bottom plate is vulcanized to the lower open end of the elastomeric air spring, are used. This bottom plate is made of metal material and has a form of plate having high resistance.

A bumper made of rubber material is generally mounted onto the bottom plate. Bumpers made of rubber function as a security element and absorb the force which occurs when the vehicle chassis suddenly falls down because of the air spring burst or the overloaded vehicle. If the bumper is not used, the whole weight of the vehicle chassis will be loaded onto the piston or bottom plate without absorbing, and in this case the breaking risk of these parts will be increased. So that the security problems will be occurred. Plastic material can also be used as bumper material. EP 0943836 and EP 0501043 numbered European Patent Applications relate to plastic bumper structures.

A bumper pin is used to mount the bumper onto the bottom plate. Rubber or plastic based bumper provides the montage of the bumper onto the bottom plate which undergoes onto the bumper pin fixed by a bolt onto the upper surface of the bottom plate. Bolt threads undergo suitable pitches inside the pin. Thus, bumper pin is fixed on the bottom plate.

At the present technique, bottom plate and bumper are stand alone each other and then bumper pin, welding etc. are used for assembling the bottom plate and bumper which independent from each other. Also it increases the production cost with a considerable amount. Currently, metallic based materials which have a high strength are used to produce the bottom plates. On the other hand bumper is made of rubber, plastic materials or combination of these two materials. To fix these two different parts, connection methods like bumper pin, welding etc. have to be used to connect these parts. Thus the labor costs and production costs increase and production speed decreases.

In the following part, some patents are explained about the bumper structure and montage of the bumpers onto the bottom plate.

EP 0943836 numbered European Patent Application relates to a shock-absorber bumper belonging to an air spring. Especially it is about fixing with stocking up one or more bumper extensities over the bumper to increase the height of the bumper which is mounted over the top side of the bottom plate with a bumper pin.

EP 0969223 numbered European Patent Application relates to an elastomeric shock-absorber mounted over the bumper pin. Elastomeric shock-absorber is supported from its sideways with a solid support placed in a metal or plastic solid support. And thus it is prevented that the flinging of the bumper from the bumper pin.

EP 0969224 numbered European Patent Application relates to a single-piece support member made of solid hard metal, on which an elastomeric member (shock-absorber) is mounted and which is welded on the bottom plate.

In EP 0501043 numbered European Patent Application, a single-piece bumper is made of solid plastic material and the inward and upward slopped claws comes into the slots on the bumper pin, thus flinging of the bumper over the bumper pin is prevented.

### BRIEF SUMMARY OF THE INVENTION

The purpose of the present invention is to provide the production of the bottom plate and bumper which is used in air suspension systems and independent from each other as a single body using reinforced plastic material.

The other purpose of the invention is to decrease of the production costs using new developed plastic bottom plate with bumper. Bottom plate with bumper can be manufactured in series with one operation step in plastic injection machine. Thus the production cost will be lower about 50% than present production cost of the bottom plate and bumper.

Another purpose of this invention is to eliminate the applications like welding, the bumper pin which is used to fix the bumpers and the bottom plate to each other in present technique thanks to the production of the single-piece bumper made of reinforced plastic. Thus, loss of cost and labor are minimized owing to composed of additional connection apparatus and connection methods.

In order to attain all the aforesaid objectives, an air suspension system has been improved which comprises a plastic or metal piston fixed to the vehicle axle and an elastomeric bellows which is air tightly vulcanized from its lower open end to the upper part of the piston and from its upper open end to the metal plate fixed to the vehicle chassis to form a pressured air chamber, characterized in that; it comprises a single-piece bottom plate with bumper, which is completely made of reinforced plastic material, consists of a compression part vulcanized to the elastomeric bellows and a bumper part absorbing the loads and which is mounted to the upper side of the piston after that it is vulcanized to the lower open end of the elastomeric bellows.

Further that to attain all the aforesaid objectives, a production method of a bottom plate with bumper of an air suspension system comprising a plastic or metal piston fixed to the vehicle axle and an elastomeric bellows which is air tightly vulcanized from its lower open end to the upper part of the piston and from its upper open end to the metal plate fixed to the vehicle chassis to form a pressured air chamber, characterized in that; it comprises the following process steps,
placing of a metal connection apparatus into a mold of a plastic injection machine,
the surrounding area of the connection part is completely covered with reinforced plastic material during the plastic injection process and the single-piece bottom plate with bumper made of reinforced plastic material is obtained.

### BRIEF DESCRIPTION OF THE DRAWINGS

FIG. 1 is the side cross-sectional view of the air suspension system.

FIG. 2 is the perspective view of the bottom plate with bumper.

FIG. 3 is the cross-sectional view of the bottom plate with bumper.

FIG. 4 is the bottom view of the bottom plate with bumper.

### REFERENCE NUMBERS

1. Air suspension system
2. Elastomeric bellows
3. Plate
3.1 Air inlet hole
3.2 Connection bolt
4. Piston
5. Bottom plate with bumper
5.1 Compression part
5.2 Bumper part
5.2.1 Upper surface
5.2.2 Core gap
5.3 Reinforcing rim
6. Connection apparatus
6.1 Connection hole
7. Connection bolt

### DETAILED DESCRIPTION OF THE INVENTION

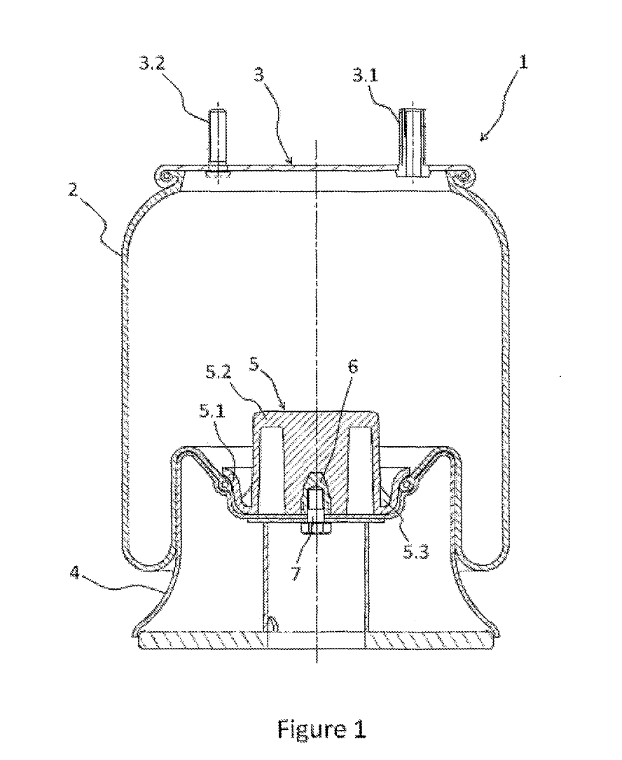

In FIG. 1, the perspective view of the air suspension system (1) is given. Air suspension systems (1) generally comprise a plastic or metal piston (4) fixed to the vehicle axle and an elastomeric bellows (2) which is air tightly vulcanized from its lower open end to the upper part of the piston (4) and from its upper open end to the metal plate (3) fixed to the vehicle chassis. The lower and upper open ends of the elastomeric bellows (2) are fixed onto the piston (4) and plate (3) in air-tightly manner. Thanks to this, a pressured air chamber is formed inside the elastomeric bellows (2), which absorbs the loads and the vibrations occurred during the vehicle motion.

There is an air inlet hole (3.1) on the plate (3) to fill the pressured air into the elastomeric bellows (2) or to discharge the pressured air inside the bellows (2) to the outside. Further, there are connection bolts (3.2) on the plate (3) to provide the connection between the plate (3) and the vehicle chassis.

In the prior art, at the some types of the air suspension systems (1), bottom plates mounted to the upper side of the piston (4) after that the bottom plates are vulcanized to the lower open end of the elastomeric bellows (2). These bottom plates are made of high resistant metal material.

A bumper made of rubber material, is generally mounted onto the bottom plate. Bumpers made of rubber, function as a security element and absorb the force which is occurred as a conclusion that the vehicle chassis suddenly falls down because of the air spring burst or the overloaded vehicle. If the bumper is not used, the whole weight of the vehicle chassis will be loaded onto the piston or bottom plate without absorbing, and in this case the breaking risk of these parts will be increased. So that, the security problems will be occurred. Alternatively, bumpers can be mounted to the lower side of the plate (3). Plastic material can also be used as bumper material.

At the present technique, the bottom plate and the bumper are stand alone each other and then bumper pin, welding etc. are used for assembling the bottom plate and bumper which are independent from each other. Also it increases the production cost with a considerable amount. Currently, metallic based materials which have a high strength are used to produce the bottom plates. On the other hand bumper is made of rubber, plastic materials or combination of these two materials. To fix these two different parts, connection methods like bumper pin, welding etc. have to be used to connect these parts. Thus the labor costs and production costs increase and production speed decreases.

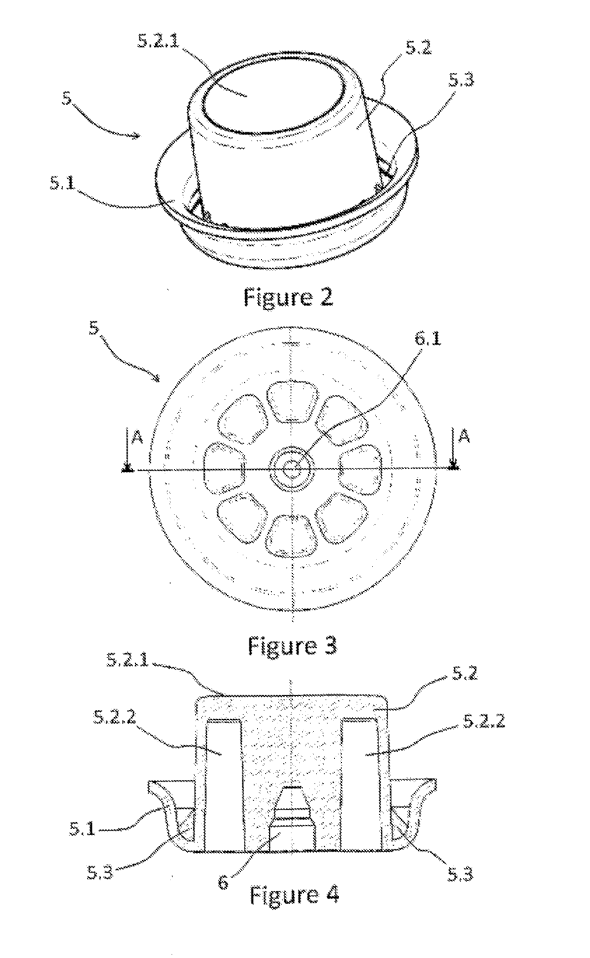

As it seen in FIGS. 2, 3 and 4, single-piece bottom plate with bumper (5), is made of reinforced plastic material. Bottom plate with bumper (5), provides the load absorption, further that it provides the montage of the elastomeric bellows (2) onto the piston (4) in air-tightly manner, after that it is vulcanized to the lower end of the elastomeric bellows (2). Single-piece bottom plate with bumper (5), consists of a compression part (5.1) and a bumper part (5.2).

Bumper part (5.2) absorbs the first load which comes on it, as a result of the discharge of the air inside the elastomeric bellows (2) or overloaded cases. So that the bumper part (5.2) minimizes the breaking risk of the parts such as piston, plate etc. Bumper part (5.2) preferably comprises a flat upper surface (5.2.1) countering the loads.

The compression part (5.1) of the bottom plate with bumper (5), has the same function of the bottom plate in prior art. Curved side edge of the compression part (5.1) is vulcanized onto the cylindrical lower open end of the elastomeric bellows (2) and after that the vulcanized bottom plate with bumper (5), is completely mounted onto the piston (4) air-tightly (see the FIG. 2).

The reinforcing rims (5.3) are formed between the compression part (5.1) and the bumper part (5.2) for increasing the resistance of the bottom plate with bumper (5). Bottom plate with bumper (5), is completely made of plastic based material in a plastic injection machine with only one process. Thanks to this, the production costs is decreased in a rate of the 50% and further that the production and montage time is decreased and the serial production capacity in increased. In order to facilitate the plastic injection process and to provide the material savings, plurality of core gaps (5.2.2) are formed inside the bumper part (5.2). Alternatively, the plastic single-piece bottom plate with bumper (5) can be produced without forming the core gaps (5.2.2).

There is a connection apparatus (6) at the lower-middle part of the bottom plate with bumper (5). Connection apparatus (6) is made of metal material. The function of the connection apparatus (6) is to provide the assembly of the bottom plate with bumper (5) onto the piston (4). There is a connection hole (6.1) having threads inside the connection apparatus (6). The connection of the piston (4) and the bottom plate with bumper (5) is provided by a connection bolt (7) crossing through a connection hole (6.1).

The metal connection part (6) is formed integrally with said bottom plate with bumper (5) during the plastic injection process. Plastic injection process is realized after the connection part (6) is placed into the mold of the plastic injection machine. After the plastic injection process the surrounding area of the connection part (6) is completely covered with reinforced plastic material and the single-piece bottom plate with bumper (5) is obtained. The bumper part (5.2) of the bottom plate with bumper (5), the compression part (5.1) and the reinforcing rims (5.3) are integrally made of reinforced plastic material in a plastic injection machine with only one process. The plastic material used to produce bottom plate with bumper (5), is preferably reinforced with fiberglass, fiber etc. and the resistance against the loads is increased.

1. An air suspension system comprising a plastic or metal piston fixed to the vehicle axle and an elastomeric bellows which is air tightly vulcanized from its lower open end to the upper part of the piston and from its upper open end to the metal plate fixed to the vehicle chassis to form a pressured air chamber, characterized in that; it comprises a single-piece bottom plate with bumper, which is completely made of reinforced plastic material, comprises a compression part vulcanized to the elastomeric bellows and a bumper part absorbing the loads and which is mounted to the upper side of the piston after that it is vulcanized to the lower open end of the elastomeric bellows.

2. Air suspension system according to claim 1, characterized in that it comprises a metal connection apparatus, including a connection hole with threads, providing the fixing of the bottom plate with bumper onto the piston and which is formed during the plastic injection process integral with said bottom plate with bumper.

3. Air suspension system according to claim 1, characterized in that the bumper part comprises a flat upper surface countering the loads.

4. Air suspension system according to claim 1, characterized in that it comprises reinforcing rims which are formed between the compression part and the bumper part for increasing the resistance of the bottom plate with bumper.

5. A production method of a bottom plate with bumper of an air suspension system comprising a plastic or metal piston fixed to the vehicle axle and an elastomeric bellows which is air tightly vulcanized from its lower open end to the upper part of the piston and from its upper open end to the metal plate fixed to the vehicle chassis to form a pressured air chamber, characterized in that; it comprises the following process steps,
placing of a metal connection apparatus into a mold of a plastic injection machine,
the surrounding area of the connection part is completely covered with reinforced plastic material during the plastic injection process and the single-piece bottom plate with bumper made of reinforced plastic material is obtained.
